(19) United States
(12) Patent Application Publication
(10) Pub. No.: US 2026/0183768 A1
(43) Pub. Date: Jul. 2, 2026

(54) PIPETTE TIP CARTRIDGE

(71) Applicant: Mettler-Toledo Rainin, LLC, Oakland, CA (US)

(72) Inventors: George Fernwood, Oakland, CA (US); Travis Wold, Oakland, CA (US)

(21) Appl. No.: 19/006,015

(22) Filed: Dec. 30, 2024

(51) Int. Cl. B01L 9/00

(52) U.S. Cl. CPC B01L 9/543; B01L 2200/02; B01L 2200/0689; B01L 2300/041

(57) ABSTRACT

A pipette tip, tip adapter, or tip cartridge includes a sealing tube with a negative or reverse taper to be inserted into one or more pipetting channels of a pipette; the sealing tube is characterized by a negative draft angle to cause the tip, adapter, or cartridge to be drawn against the dispensing head when mounted, sealed, and gripped. A tip rack assembly may comprise cartridges and pipette tips along with a pipette tip rack base and lid.

### FIELD OF THE INVENTION

The invention relates to air displacement pipette tips and tip adapters, and more particularly to self-stabilizing pipette tips and tip adapters for multichannel pipettes.

### BACKGROUND OF THE INVENTION

Air displacement pipettes are typically used to accurately and precisely transfer liquids between vessels in a laboratory environment. Common vessels are microtiter plates, test tubes and reservoirs.

Air displacement pipettes frequently make use of a piston and cylinder arrangement, which is used to create positive and negative pressure in an attached pipette tip. When the open end of the tip is placed into a liquid, the change in pressure causes the liquid to be aspirated into, or dispensed from, the interior of the pipette tip.

The most basic type of air displacement pipette is a single-channel handheld pipette, which can be either manually driven through direct user control of the piston, or motor driven. While easy to use, they can be slow and meticulous to operate when many liquid transfer operations must be performed. A step up from a single-channel handheld pipette is a multichannel handheld pipette, which again can either be manually driven through direct user control of the piston or motor driven; typically, all channels of a handheld multichannel pipette are driven simultaneously, and thus aspirate or dispense the same quantity of liquid across the channels.

For laboratories and other users requiring more throughput than can be managed with a handheld pipette, benchtop and freestanding air displacement pipettes have become popular in recent years. Such larger pipettes typically are capable of aspirating and dispensing many channels at once—typical arrangements are an 8×12 array (96 channels) or a 16×24 array (384 channels), and like their smaller relatives they can be manually or electrically driven. These larger array-style multichannel pipettes represent a great advance in throughput and efficiency, particularly when handling microplates and other receptacles that are also arranged in an array configuration. Such instruments facilitate accurate, precise, and consistent repetitive liquid transfers in large-scale experiments and high-throughput protocols, but when it is necessary to perform operations on a smaller subset of channels, an array-style instrument may not be the best choice, and many laboratories and users resort to using handheld single-channel and multichannel pipettes when needed.

Typical laboratory pipettes employ consumable pipette tips that are disposed of after every liquid transfer or as needed to avoid cross-contamination between liquid samples. It is generally easy to mount and eject tips with a handheld pipette - the user is in control of the entire process, from aligning the pipette over the tips in a rack, to pressing the nozzle or nozzles of the pipette into the tips, and carefully lifting the pipette with the tips attached. When a transfer operation is completed, the tips are usually ejectable by pressing a button after the user positions the pipette over a trash receptacle.

With an array-style pipette, mounting and ejecting tips becomes more challenging. Alignment across all 96 or 384 channels is critical, as is ensuring that an airtight seal is created on each of the tips in the array. Because of this, some manufacturers have moved to tip cartridges rather than individual tips, as cartridges are generally easier to handle and can help facilitate alignment and sealing.

As shown in U.S. Pat. No. 11,559,802 B2, for example, benchtop and standalone pipette instruments can also be optimized to improve tip mounting and ejection forces by using structures like a sealing o-ring that is compressed against the tip cartridge channels only when the cartridge is meant to be retained on the instrument.

Tip cartridges present a significant disadvantage when a user wishes to operate on a subset of a microplate or other array of receptacles, rather than the full 96 or 384 wells. As noted above, multichannel pipettes typically have all channels driven simultaneously, so attempting an operation on a subset of channels using a cartridge-style tip adapter becomes essentially impossible—it is all or nothing. Even if it were possible to drive only selected piston/cylinder channels, it would be wasteful to dedicate an entire tip cartridge to a small operation, and it may be undesirable to have unused tip ends dip into and be removed from what might be extremely sensitive samples.

To remedy this, it may be possible to create tip cartridges that attach to only a single row or column of pipetting channels. All of the channels of a traditional array-style pipette will still operate, with the piston moving in each cylinder to displace air, but because only some tips are attached liquid will only be aspirated and dispensed on the corresponding channels.

However, in instruments designed to use a tip cartridge, there may be some disadvantages to such an approach: single-row or single-column cartridges, or other sub-array form factors, can be unstable (i.e., easily tippable when subject to even a small lateral force) or difficult to mount and eject cleanly using an instrument that is primarily configured for use with a whole-array tip adapter.

A common application for a handheld multichannel pipette is the task of serial dilution. Serial dilution is a technique used in laboratories to create a range of concentrations of a substance, typically a sample in a diluent. This technique involves diluting a concentrated sample in a stepwise fashion, where each dilution is made by taking a specific volume of the previous dilution and adding it to a new quantity of diluent. Serial dilution is frequently performed across an entire multiwell plate, with dispenses sequentially made column by column, or row by row, with concentration decreasing across the plate.

Serial dilution can be used for concentration control, which allows researchers to obtain a series of known concentrations for various experiments, making it easier to study the effects of concentration on a particular reaction or biological activity. Serial dilutions are also commonly used in microbiology to estimate the number of microorganisms in a sample by determining the dilution at which growth occurs. In titrations, serial dilution can assist in preparing standard solutions to accurately determine the concentration of an unknown solution. Serial dilution is also often used to create standard curves for quantitative analysis, allowing for the determination of unknown concentrations based on comparison with known standards.

Overall, serial dilution is a fundamental technique that enhances accuracy and reliability in quantitative analysis across various scientific disciplines. However, the use of a handheld pipette to perform many repetitive aspiration and dispense operations in the course of performing a serial dilution can be tedious, subject to occasional errors, and lead to ergonomic issues. Accordingly there is a need for an instrument and tips that can perform serial dilution, and other tasks, effectively and easily.

### SUMMARY OF THE INVENTION

As noted above, the use of handheld pipettes for serial dilution and similar laboratory tasks (for example, various high throughput applications and protocols in which one or more steps are to be performed on a subset of wells in the plate) has some significant disadvantages. Some or all of these disadvantages can be addressed via automation and the use of benchtop and standalone instruments where the working position is more easily tracked because the user has no need to use their arm and hands to move the pipette and dispense into the correct receptacles. However, most benchtop and standalone instruments are not conveniently used to transfer fewer than a full plate full of samples at a time.

This deficiency can be addressed by using single rows or columns of tips on a benchtop or standalone pipette, but for such instruments that use standard individual pipette tips, loading tips in this manner can be inconvenient and lead to additional handling and contamination. Furthermore, other benchtop and standalone instruments that use tip cartridges may not be readily usable that way without modifying the instrument or cartridges. And if a custom cartridge is used to set up a single row or column of aspiration and dispensing tips, such a cartridge may be laterally unstable or unreliable, as only full array type cartridges are typically supported.

A pipette tip cartridge according to the invention is configured specifically to enable the use of a single row or column of pipetting tips on a benchtop or standalone instrument. The cartridge mounts to a pipetting head of the instrument in a way that urges the cartridge against the bottom of the head while the individual channels in the cartridge are sealed. By being essentially forced against the bottom of the head, the cartridge is more resistant to lateral instability and sealing issues can be reduced.

One type of pipette tip cartridge according to the invention includes a plurality of pipetting channels representing either a single line (row or column) or multiple lines of tips, generally representing a subset of channels that the instrument is capable of operating at one time. As used herein, the term “row” as applied to a rectangular matrix of pipetting channels means a 1-by-X strip of tips along the long axis of the instrument's matrix of channels. On a typical 96-channel instrument, a row would comprise a single linear arrangement of twelve channels. Similarly, a “column” herein means 1-by-Y strip of tips along the short axis of the instrument's matrix of channels. On a typical 96-channel instrument, a column would comprise a single linear arrangement of eight channels.

Individual columns and rows are not the only configurations enabled in a pipette tip cartridge according to the invention; other subsets and arrangements are possible and some of them will be described herein.

It should be recognized that a benchtop or standalone pipetting instrument can be configured to match an 8×12 array of channels (as seen in a typical 96-channel well plate or a standard rack of pipette tips). But other form factors exist: 384-channel plates are usually arranged in a 16×24 array, and 1536-channel well plates are typically in a 32×48 array. Other configurations such as square, or 24-channel, or other shapes or dimensions can readily be envisioned.

Accordingly, a pipette tip cartridge according to the invention allows a benchtop or standalone pipetting instrument to perform repetitive laboratory tasks like serial dilution and other applications that would otherwise call for a handheld pipette, but with potentially greater throughput, more reliability and repeatability, and fewer errors. Of course, the instrument retains its ability to aspirate and dispense entire plates at a time (e.g., for plate filling) with its usual consumable cartridge, so two common laboratory instruments can be replaced with one instrument and different application-specific tip cartridges according to the invention.

### BRIEF DESCRIPTION OF THE DRAWINGS

These and other objects, features, and advantages of the invention will become apparent from the detailed description below and the accompanying drawings, in which:

FIG. 1 shows a benchtop pipetting instrument with a single column tip cartridge according to the invention mounted thereon;

FIG. 2 is an orthographic view of a tip cartridge according to the invention with no pipette tips attached;

FIG. 3 is an orthographic view of the tip cartridge of FIG. 2 with a column of pipette tips attached thereto;

FIG. 4 is a side view of the combination shown in FIG. 3;

FIG. 5 is an exploded side view of the combination shown in FIG. 3, with the tips removed from the cartridge;

FIG. 6 is a bottom view of the tip cartridge of FIG. 2 with no tips attached;

FIG. 7 is a top view of the tip cartridge of FIG. 2;

FIG. 8 is a cross sectional view of the tip cartridge of FIG. 2 taken along the longitudinal centerline of the cartridge;

FIG. 9 is an enlarged view of a portion of the cross sectional view of FIG. 8;

FIG. 10 is a partial cross sectional side view of a cartridge and tip according to the invention mounted to a pipetting head;

FIG. 11 is an orthographic view of a tip cartridge according to an embodiment of the invention in which only alternating channels of the cartridge are attachable to pipette tips;

FIG. 12 is an orthographic view of a single-channel embodiment of a tip cartridge according to the invention;

FIG. 13 is an orthographic view of a 2×2 four-channel embodiment of a tip cartridge according to the invention;

FIG. 14 is an orthographic view of a pipette tip rack base holding eleven columns of pipette tip cartridges according to the invention and one tip riser according to the invention;

FIG. 15 is an orthographic view of the tip riser illustrated in FIG. 14; and

FIG. 16 is an exploded side view of a pipette tip rack base, a tip riser, a tip cartridge with pipette tips, and a pipette tip rack lid all according to the invention.

### DETAILED DESCRIPTION OF THE INVENTION

The invention is described below, with reference to detailed illustrative embodiments. It will be apparent that a multichannel air displacement pipette according to the invention may be embodied in a wide variety of forms. Consequently, the specific structural and functional details disclosed herein are representative and do not limit the scope of the invention.

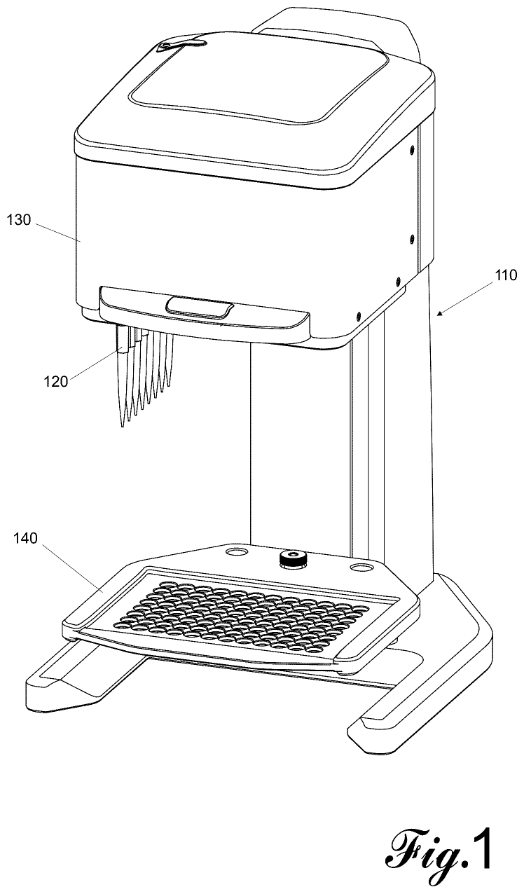

Referring initially to FIG. 1, an exemplary benchtop pipette instrument 110 is shown with a column of tips 120 attached; the column of tips 120 represents an embodiment of the invention that will be discussed in further detail below. The illustrated instrument 110 is electronically controlled and driven by motor for aspiration, dispensing, tip mounting, and tip ejection, but the positioning of its head 130 is performed manually by a user. A tray 140 may also be positioned by the user.

One embodiment of a tip cartridge 210 according to the invention, which may also be referred to as a “tip adapter,” is illustrated. The cartridge 210 represents a column of tips usable with a pipetting instrument like the one shown in FIG. 1; it includes eight channels to attach to eight corresponding channels in a column of the pipetting head 130, in any row of the head. Typically, in such a cartridge 210—and the respective pipetting head 130—the channels are on 9 mm spacing compatible with standard pipette tip racks and 96-well plates.

The cartridge 210 as shown herein is injection molded from a stable and relatively chemically inert polymer like polypropylene; other materials may also be used and would be readily apparent to a practitioner of ordinary skill.

The cartridge 210 includes three primary features: at least one upward-facing sealing tube 220 configured for insertion into the head 130 of the pipetting instrument 110, at least one downward-facing mounting tube 230 intended to receive pipette tips, and a cartridge segment 240 extending around the sealing tube and mounting tube. As shown, the cartridge 210 includes eight sealing tubes 220 and eight corresponding mounting tubes; the cartridge segment connects the sealing/mounting tube pairs and maintains the spacing between them for a compatible fit with the pipetting head 130.

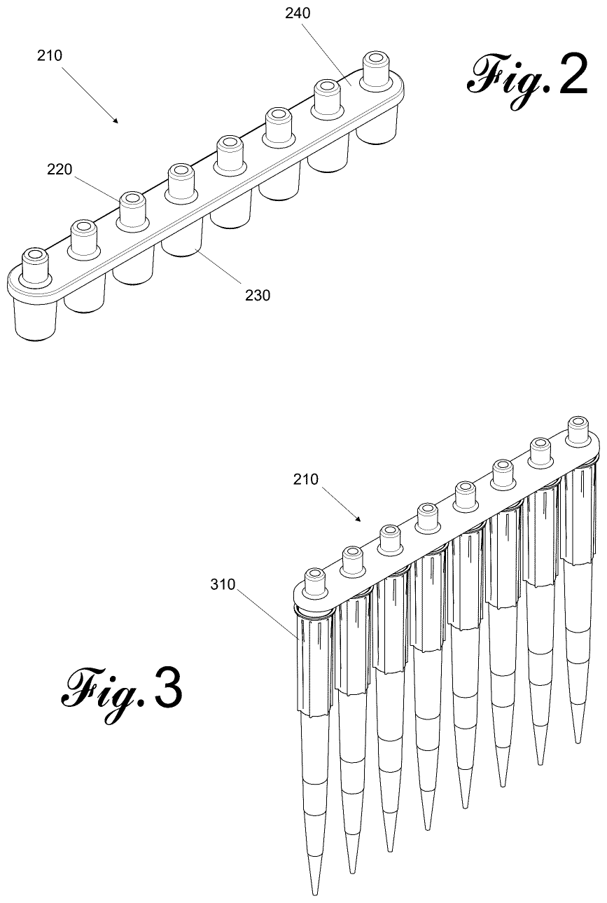

FIG. 3 shows the cartridge 210 of FIG. 2 with pipette tips 310 mounted thereto. Generally, one pipette tip is mounted to each downward-facing mounting tube, but in some embodiments that configuration is not required. The mounting tubes 230 are sized such that a compatible pipette tip 310 is frictionally attachable and sealable thereto, either during manufacturing or at any other stage prior to use.

It will be recognized that as illustrated, both the upward-facing sealing tubes 220 and the pipette tips 310 have narrow portions, and as illustrated below the tip cartridge 210 and the tips 310 have relatively wider open interiors, so in the illustrated embodiment it is considered not feasible to fabricate the cartridge and tips as a single molded piece. However, alternative embodiments are possible in which, for example, the sealing tubes 220 are wider and present unimpeded access to the interior portion of the cartridge 210 and tips 310, and such a version may be integrally molded. Other methods of fabrication are, of course, possible and are deemed to be within the scope of this invention.

A side view of the combination of cartridge 210 and pipette tips 310 is shown in FIG. 4. As will be apparent from the drawing, the pipette tips 310 do not necessarily meet the cartridge segment 240 flushly; it is sufficient for the tips 310 to be securely mounted to and fully sealed against the mounting tubes 230. As noted above, the fit between the tips 310 and the cartridge 210 is generally frictional, but in various embodiments may be adhered via heat or ultrasonic welding, adhesive, or other means.

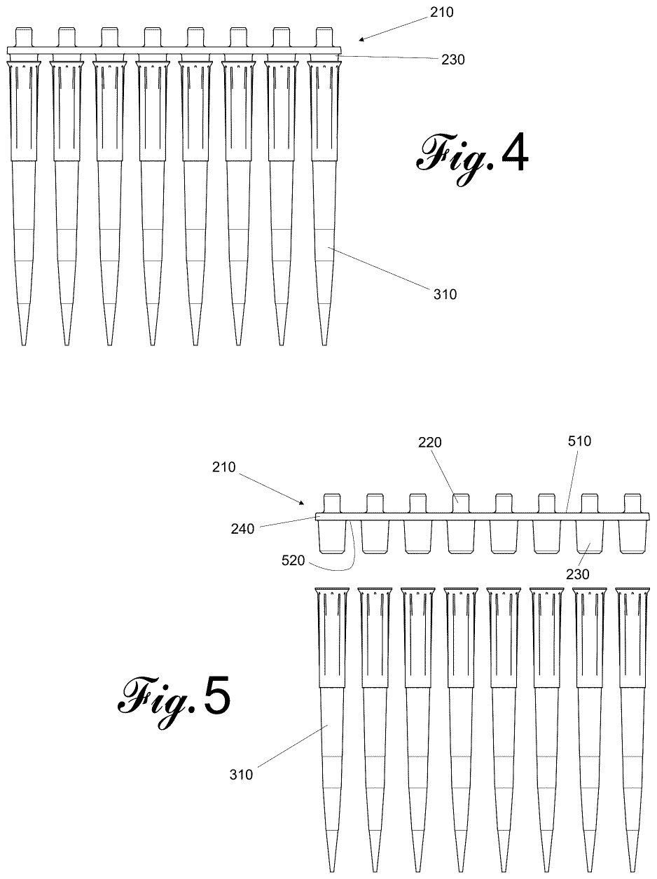

FIG. 5 shows the separate components of FIGS. 3-4 in an exploded view, which may also be representative of the components prior to final assembly. In the illustrated embodiment, each of the tips 310 (or at least one of them) is subsequently mounted to a corresponding one of the channels of the adapter 210 as shown. The cartridge segment 240 has a top surface 510 and a bottom surface 520 visible.

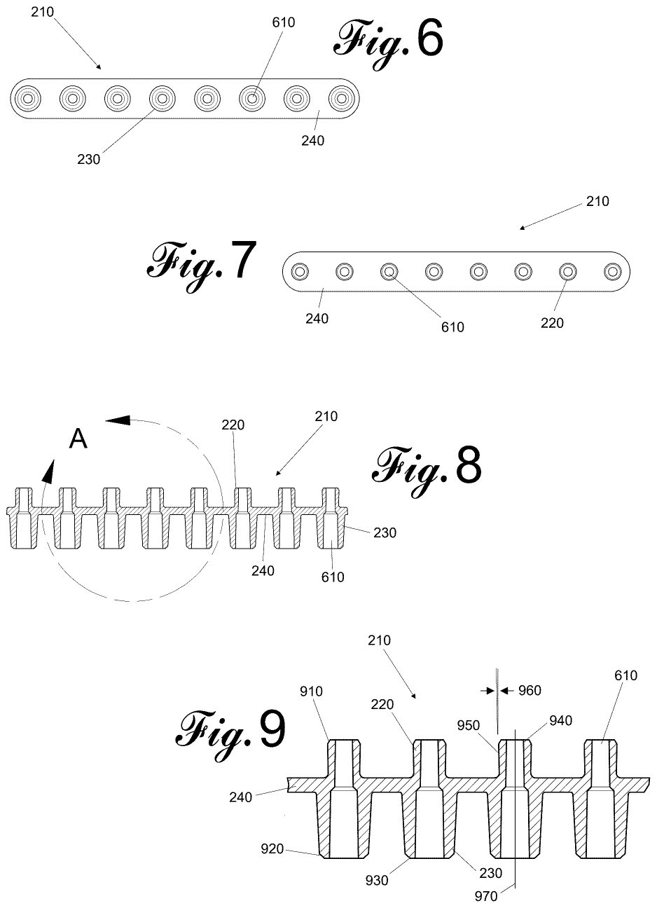

A bottom view of the cartridge 210 is shown in FIG. 6, with each of the mounting tubes 230 and the bottom surface 520 of the cartridge segment 240 visible. As is apparent in this view, each of the mounting tubes 230 and the cartridge segment 240 defines an aperture 610 passing from a top of the cartridge 210, through the cartridge segment 240, and to a bottom of the cartridge 210.

Similarly a top view of the cartridge 210 is shown in FIG. 7, and the sealing tubes 220 are visible in this view. The apertures 610 are also visible, having passed through from the other side of the cartridge 210.

FIG. 8 shows a cross-sectional side view of the cartridge 210, taken through the longitudinal centerline of the cartridge 210. Visible in this view are the cartridge segments 240, the sealing tubes 220, the mounting tubes 230, and the apertures 610. In the illustrated embodiment the apertures 610 are wider through the mounting tubes 230 than through the sealing tubes 220 with a transition therebetween; this configuration is intended to facilitate molding and conserve raw materials.

FIG. 9 shows an enlargement of a portion of the view shown in FIG. 8, taken from the section A called out in FIG. 8. As shown herein, each of the sealing tubes 220 bears an upper bevel 910 and each of the mounting tubes 230 bears a lower bevel; this is for molding and manufacturing considerations, and also to ensure that no loose material interferes with mounting the tips 310 to the cartridge 210 or the cartridge 210 to the head 130 of the instrument 110.

As FIG. 9 shows, each of the mounting tubes 230 is a mostly smooth frustoconical shape (excluding the bevels 920 and a transition to the cartridge segment 240), tapered and narrowing from the cartridge segment 240 to its respective end 930 to match an interior taper of a corresponding pipette tip 310, thereby enabling a secure and airtight fit between the two. The mounting tubes need not be entirely smooth; features may be present to facilitate mounting of various kinds of pipette tips. In some embodiments, the profile of the mounting tubes may be different, either to fit pipette tips that have a substantially cylindrical mounting portion, or to fit pipette tips having an exterior sealing surface, or to provide a stop surface to prevent over-insertion, to provide a few examples. Various other configurations will be readily apparent.

Each of the sealing tubes 220 also extends from the cartridge segment 240 to a

respective end 940. The shape of the sealing tubes 220 is, according to the invention, a generally smooth frustoconical shape (excluding the bevels 910 and an area of transition where the sealing tubes meet the segment 240), but having a reverse or negative taper as shown. Thus, the sealing tubes 220 are narrower (i.e., having a relatively smaller diameter) near the cartridge segment 240 than near the respective end 940 of the tube 220. An angle 960 between a vertical edge 950 of the sealing tube 220 and an exemplary vertical axis 970 of the corresponding aperture 610 (about which the sealing tube 220 is generally symmetric) is generally between about one half degree (0.5°) and about four degrees (4°). In an embodiment of the invention the angle ranges between about one degree (1°) and about three degrees (3°). In a further embodiment of the invention, the angle is about two degrees (2°). The angle should be selected to be wide enough to provide ample retention force between the pipetting head 130 and the cartridge 210, while small enough to enable ejection molding.

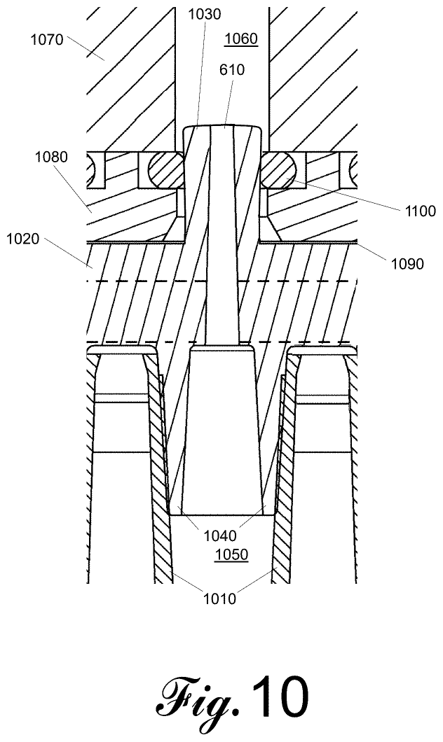

The interface between a cartridge according to the invention and the pipetting head 130 is illustrated in the sectional view of FIG. 10. As shown, a pipette tip 1010 is mounted to a downward-facing mounting tube 1040. The mounting tube 1040 is coupled to a cartridge segment 1020. Similarly, a sealing tube 1030, also coupled to the cartridge segment 1020, is inserted into a channel 1060 of a pipetting instrument 110. The aperture 610 of the cartridge opens to both the channel 1060 of the instrument 110 and an interior 1050 of the pipette tip.

Each channel 1060 of the head 130 incorporates a peripheral o-ring 1100 configured to receive, seal against, and grip the sealing tube 1030 extending into the channel 1060. The head 130 includes a cylinder block 1070 (which includes the reciprocating piston and piston seal typical of air displacement pipettes) and a compression plate 1080. When the block 1070 and compression plate 1080 are spaced apart, the o-ring 1100 remains in a relaxed configuration, allowing the sealing tube 1030 to pass easily into the channel 1060 for mounting and ejection. When the block 1070 and the plate 1080 are drawn together as shown in FIG. 10, the o-ring 1100 is compressed and urged against the negative taper of the sealing tube 1030. This has the effect of drawing the sealing tube 1030 and the cartridge 210 up against the compression plate 1080, to a configuration where an upper surface 1090 of the cartridge is flat against the compression plate 1080. Because of the taper, the pressure from the o-ring 1100 exerts a force both laterally and upwardly against the sealing tube 1030, thereby keeping the cartridge 210 secure against the pipetting head 130. When the o-ring is in such a compressed condition, it seals the sealing tube 1030 against both the block 1070 and the plate, and thus also against the channel 1060.

Several additional embodiments of a tip cartridge according to the invention are shown in FIGS. 11-13. The primary illustrated embodiment herein has been described as an eight-channel cartridge for use with a single column in a 96-channel pipetting instrument. Of course, a twelve-channel cartridge would be usable with a single row in a similar instrument. Other intermediate and smaller sizes are also possible, with essentially any number of channels in a column or row.

The embodiment of FIG. 11 shows an alternating row cartridge 1110, which enables the use of four channels in a column of eight. As with other cartridges according to the invention, each operative channel has a sealing tube 1120, a mounting tube 1130, but a cartridge segment 1140 further defines holes 1150 to allow unused channels to remain unobstructed, so reciprocating pistons in the unused channels will be able to move air in and out without affecting the channels in use. Although the illustration of FIG. 11 shows an alternating configuration, other arrangements are possible, with some channels enabled and others left open. It should also be apparent that the cartridge 1110 of FIG. 11 can be rotated 180 degrees (180°) about a vertical axis so that the other set of alternating channels can be used. In an embodiment of the invention, a full adapter cartridge 210 may be used without certain tips attached to enable similar functionality.

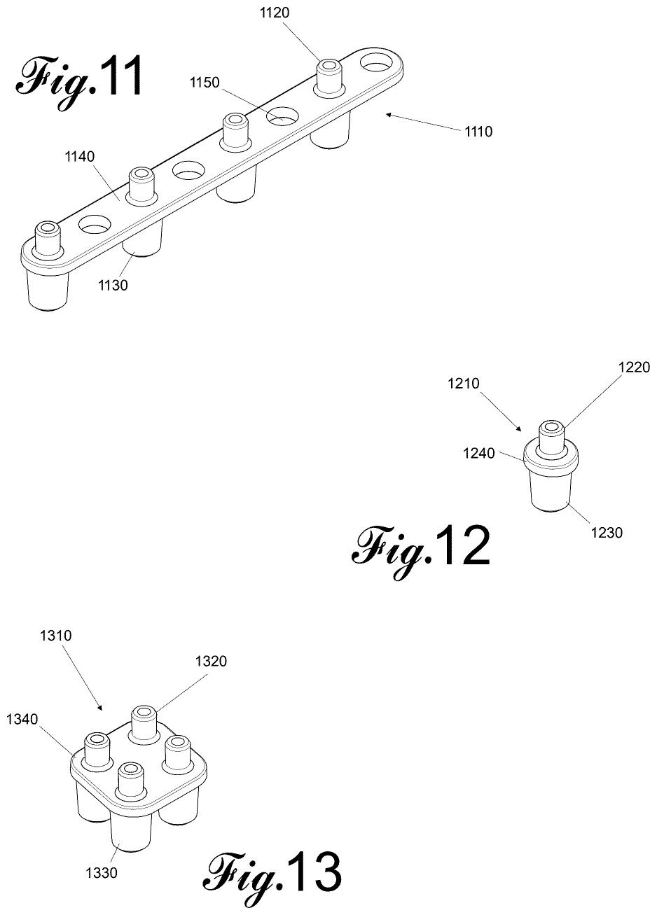

The embodiment of FIG. 12 shows a single-tip cartridge 1210. This cartridge enables only one channel to be used at a time, and it comprises essentially the same features: a sealing tube 1220, a mounting tube 1230, and a cartridge segment 1240. The functionality is essentially the same, but it is advantageous to provide the cartridge segment 1240 with a round and rotationally invariant profile (when rotated about a vertical axis) to enable such a cartridge 1210 to be used in any orientation. It should be recognized that such a tip cartridge may also be used with single-channel and multichannel pipettes.

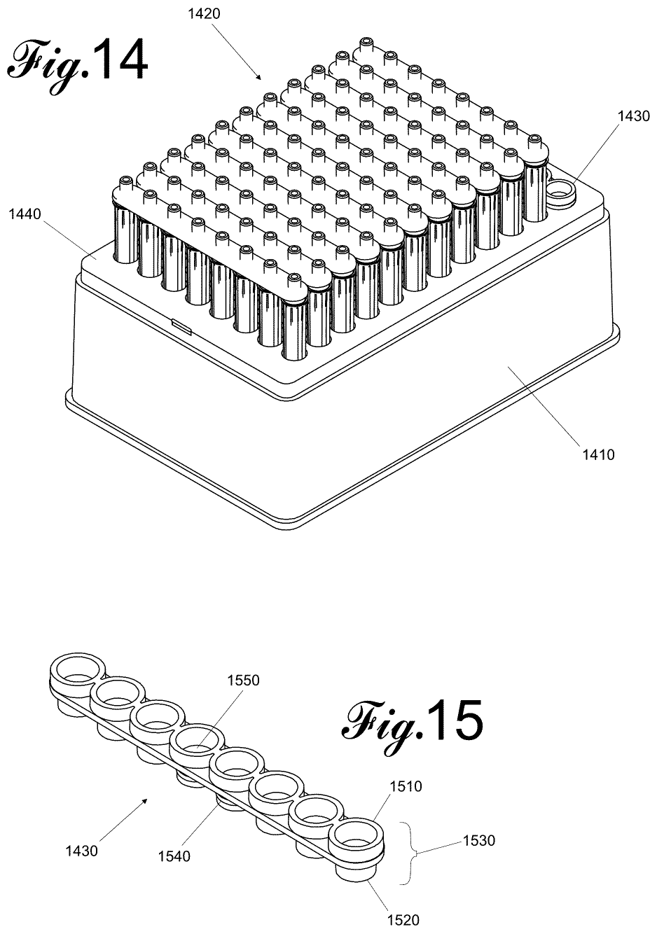

Nothing limits an embodiment of the invention set forth herein to a single row or column of channels, and accordingly, a 2×2 cartridge is shown in FIG. 13. This embodiment of a cartridge 1310 also includes sealing tubes 1320, mounting tubes 1330, and a cartridge segment 1340. However, in this case, the cartridge segment extends in two dimensions to accommodate an array of channels also extending in two dimensions. Other configurations with alternative numbers of channels along each horizontal axis, as well as irregular configurations, are also considered within the scope of the invention.

FIG. 14 shows a pipette tip rack base 1410 holding eleven rows of pipette tip cartridges 1420, with tips attached, and a twelfth row comprising a pipette tip riser 1430. The cartridges 1420 and the riser 1430 all extend from a top surface 1440 of the base 1410. It will be appreciated that when attempting to use a pipette tip cartridge according to the invention selected from a rack full of tips and cartridges, a typical benchtop or standalone pipetting instrument will not be selective—when mounting tips and cartridges, anything within range of the head 130 (FIG. 1) will be gripped and used. Accordingly, it is advantageous to provide a capability to selectively isolate one or more of the desired cartridges 1420 for mounting and use, without disturbing other cartridges held by the pipette tip rack base 1410. The pipette tip riser 1430 provides that capability by holding a single cartridge at an increased height relative to the other cartridges 1420 in the rack base 1410. As shown in FIG. 14, the pipette tip riser 1430 fits into a respective set of holes in the pipette tip rack base 1410. A cartridge with tips may then be placed into the riser, and the whole rack base 1410 may then be placed into the tray 140 of the instrument 110 (FIG. 1) for use. After that cartridge is used and disposed of, another cartridge 1420 may be removed from the rack base 1410 and placed into the riser 1430, and so on.

The pipette tip riser 1430 is illustrated in more detail in FIG. 15. The riser 1430 comprises at least one upward-facing projection 1510 and at least one corresponding downward-facing projection 1520, together making up a riser channel 1530. Where a cartridge 1420 has more than one channel, the riser 1430 preferably also has a plurality of channels, which are laterally spaced according to the distance between channels in the cartridge 1420 and corresponding holes in the pipette tip rack base 1410. In a typical 8×12 rack arrangement, the upward-facing projections 1510, the downward-facing projections 1520, and therefore the riser channels 1530, are on a nine millimeter (9 mm) center-to-center spacing. With other rack formats and tip cartridge formats, other corresponding spacings would be appropriate.

The riser 1430 further comprises at least one retention element 1540 at a downward-facing projection 1520 to ensure the riser 1430 remains in the rack base 1410 when the cartridge 1420 is mounted to an instrument head 130 and removed from the rack. Each of the riser channels 1530 in the illustrated pipette tip riser 1430 defines a bore 1550 that receives a pipette tip from the cartridge 1420, holding the tip and cartridge 1420 higher in the base 1410 than the remaining cartridges 1420, while allowing tips mounted to the cartridge 1420 to pass through and into an interior of the pipette tip rack base 1410.

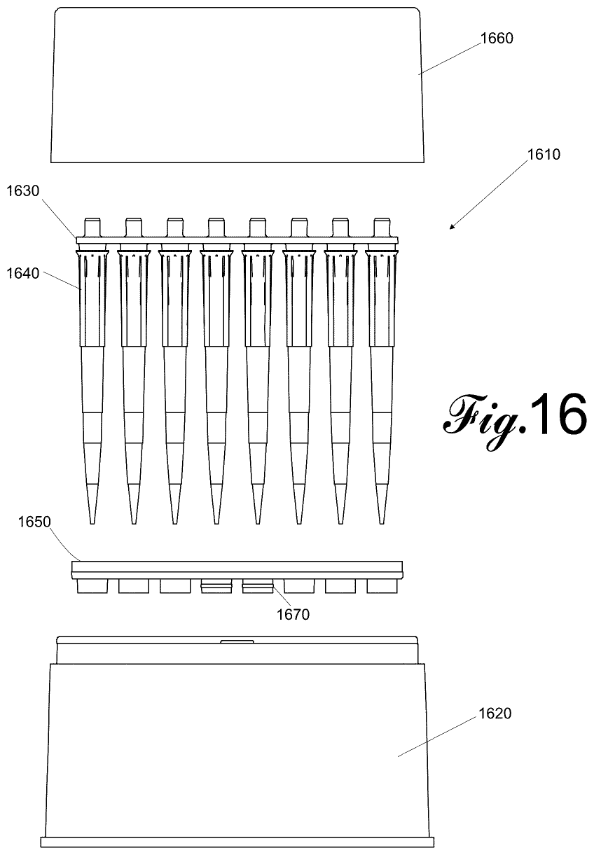

FIG. 16 shows a pipette tip rack assembly 1610 according to an embodiment of the invention in an exploded side view. The bottommost component is a pipette tip rack base 1620. A tip cartridge 1630 with pipette tips 1640 mounted thereon fit into a pipette tip riser 1650, which in turn inserts into a column of holes in the pipette tip rack base 1620. As noted above, when the tips 1640 are inserted into the riser 1650 and the riser 1650 is attached to the base 1620, the tips 1640 extend into an interior of the base. A lid 1660 covers the entire assembly 1610. In an embodiment of the invention, the lid 1660 is similar to the type of lid ordinarily used with traditional pipette tip racks, but may have an increased height to accommodate tip cartridges and risers according to the invention.

In addition to the full complement of components described above, namely a pipette tip rack base 1620 and lid 1660 holding a riser 1650 and a cartridge 1630 with tips 1640, additional columns of the pipette tip rack base 1620 may hold further cartridges 1420 without risers in place. Accordingly, when the rack assembly 1610 is first opened, it may be ready to use, fully populated with tip cartridges, with one of them already raised for use.

FIG. 16 also shows a retention element 1670, in the illustrated embodiment comprising a radial bump on one or more of the downward-facing projections of the cartridge 1630. The retention element engages and forms an interference “snap” fit with a corresponding tip hole in an upper portion of the pipette tip rack base 1620, thereby keeping the riser 1650 engaged with the base 1620 even with some force exerted when the cartridge 1630 is removed from the base 1620 by a pipetting instrument 110, a human user, or by any other laboratory apparatus. However, it is envisioned that the interference fit may be overcome with sufficient force, thereby allowing the riser 1650 to be moved to a different portion of the rack base 1620, if desired.

Although the riser (1430, 1650) is shown herein as exactly matching the configuration and corresponding dimensions of a tip cartridge used with the riser, it should be understood that there need not be such a correspondence. A pipette tip riser according to the invention may not match the configuration of cartridge: for example, a single riser may be used with a plurality of cartridges, or a single cartridge may be used with a plurality of risers, or a riser may cover more of a pipette tip rack base than the cartridge may need, or other differences may be present. In addition, it is possible to use more than one riser at a time, for example to mount a plurality of columns or rows of tips to an instrument head 130. Other configurations will be readily apparent.

It should be observed that while the foregoing detailed description of various embodiments of the present invention is set forth in some detail, the invention is not limited to those details and a pipette made according to the invention can differ from the disclosed embodiments in numerous ways. In particular, it will be appreciated that embodiments of the present invention may be employed in many different liquid-handling applications. It should be noted that functional distinctions are made above for purposes of explanation and clarity; structural distinctions in a system or method according to the invention may not be drawn along the same boundaries. Hence, the appropriate scope hereof is deemed to be in accordance with the claims as set forth below.

What is claimed is:

1. A pipette tip cartridge for use with an air displacement pipette, the cartridge comprising a flat cartridge segment and at least one channel, the channel comprising:
a sealing tube extending in a first direction from the cartridge segment;
a mounting tube extending in a second direction from the cartridge segment, the second direction being opposite the first direction; and
an aperture defined by and passing through the sealing tube, the cartridge segment, and the mounting tube, thereby providing an open passage from an end of the sealing tube to an end of the mounting tube;
wherein the sealing tube has a taper defined by a negative draft angle.

2. The pipette tip cartridge of claim 1, wherein the negative draft angle is between about one half degree (0.5°) and about four degrees (4°).

3. The pipette tip cartridge of claim 2, wherein the negative draft angle is between about one degree (1°) and about three degrees (3°).

4. The pipette tip cartridge of claim 3, wherein the negative draft angle is about two degrees (2°).

5. The pipette tip cartridge of claim 1, wherein the sealing tube has a first diameter near the cartridge segment and a second diameter near an end, and wherein the first diameter is smaller than the second diameter.

6. The pipette tip cartridge of claim 1, wherein the cartridge comprises a single channel.

7. The pipette tip cartridge of claim 1, wherein the cartridge comprises a plurality of channels along a single axis.

8. The pipette tip cartridge of claim 7, wherein the single axis comprises a row or column of channels corresponding to a row or column of channels in a pipetting instrument.

9. The pipette tip cartridge of claim 1, wherein the cartridge comprises a plurality of channels along two axes.

10. The pipette tip cartridge of claim 1, wherein the sealing tube has a frustoconical exterior surface between a junction with the cartridge segment and a bevel at an end.

11. The pipette tip cartridge of claim 1, wherein the cartridge further comprises a separate riser adapted to raise the cartridge above a top surface of a pipette tip rack base in which the cartridge is held.

12. A pipette tip rack assembly comprising:
a pipette tip rack base;
a pipette tip rack lid; and
a pipette tip cartridge inserted into the pipette tip rack base, the pipette tip cartridge comprising a cartridge segment and a plurality of channels, each channel comprising:
a sealing tube extending in a first direction from the cartridge segment;
a mounting tube extending in a second direction from the cartridge segment, the second direction being opposite the first direction;
an aperture defined by and passing through the sealing tube, the cartridge segment, and the mounting tube, thereby providing an open passage from an end of the sealing tube to an end of the mounting tube; and
a pipette tip attached to the mounting tube;
wherein the sealing tube has a taper defined by a negative draft angle.

13. The pipette tip rack assembly of claim 12, wherein the negative draft angle is between about one half degree (0.5°) and about four degrees (4°).

14. The pipette tip rack assembly of claim 13, wherein the negative draft angle is between about one degree (1°) and about three degrees (3°).

15. The pipette tip rack assembly of claim 14, wherein the negative draft angle is about two degrees (2°).

16. The pipette tip rack assembly of claim 15, wherein the sealing tube has a first diameter near the cartridge segment and a second diameter near an end, and wherein the first diameter is smaller than the second diameter.

17. The pipette tip rack assembly of claim 12, further comprising a pipette tip riser configured to raise the pipette tip cartridge above a top surface of the pipette tip rack base when the riser is mounted on the base.

18. The pipette tip rack assembly of claim 17, wherein the pipette tip riser is mounted at a top surface of the pipette tip rack base, between the pipette tip rack base and the pipette tip cartridge.
